(19) United States
(12) Patent Application Publication
(10) Pub. No.: US 2026/0113574 A1
(43) Pub. Date: Apr. 23, 2026

(54) ACOUSTIC OUTPUT DEVICES

(71) Applicant: SHENZHEN SHOKZ CO., LTD., Shenzhen (CN)

(72) Inventors: Guangyuan ZHU, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 19/428,121

(22) Filed: Dec. 20, 2025

Related U.S. Application Data
(63) Continuation of application No. PCT/CN2023/139260, filed on Dec. 15, 2023.

(51) Int. Cl. H04R 3/14; H04R 3/04

(52) U.S. Cl. CPC H04R 3/14; H04R 3/04; H04R 2460/13

(57) ABSTRACT

The present disclosure relates to an acoustic output device, the acoustic output device includes: a housing; a bone conduction vibrator, configured to generate a bone conduction sound wave, the bone conduction sound wave being transmitted to a cochlea through the housing to generate a sound; an air conduction vibrator, configured to generate an air conduction sound wave, the air conduction sound wave being transmitted to an ear of a user through a sound guiding hole on the housing; and a processing circuit, configured to provide a first audio signal to the bone conduction vibrator and a second audio signal to the air conduction vibrator. The processing circuit is further configured to adjust a low-frequency component in the first audio signal or adjust a high-frequency component in the second audio signal. By adjusting the low-frequency component in the first audio signal or adjusting the high-frequency component in the second audio signal via the processing circuit, proportions of a bone conduction component and an air conduction component in an output of the acoustic output device are made variable, thereby adjusting high-frequency and low-frequency output effects of the acoustic output device, so that the acoustic output device is suitable for different scenarios, and user experience of the acoustic output device is improved.

### CROSS-REFERENCE TO RELATED APPLICATION

This application is a continuation of International Application No. PCT/CN2023/139260, filed on Dec. 15, 2023, the contents of which are incorporated herein by reference.

### TECHNICAL FIELD

The present disclosure relates to the field of acoustic technology, and in particular to an acoustic output device.

### BACKGROUND

In an acoustic output device combining bone conduction and air conduction, the low-to-mid frequencies are generally reproduced primarily by an air conduction vibrator, while the mid-to-high frequencies are primarily reproduced by a bone conduction vibrator. However, in different usage scenarios, users have different requirements for the output of the acoustic output device.

Therefore, it is necessary to provide an acoustic output device that adjusts the output of the acoustic output device by setting components of input signals of the bone conduction vibrator and the air conduction vibrator, to achieve a good auditory experience and make the acoustic output device suitable for different scenarios.

### SUMMARY

One or more embodiments of the present disclosure provide an acoustic output device. The acoustic output device includes: a housing; a bone conduction vibrator, configured to generate a bone conduction sound wave, the bone conduction sound wave being transmitted to a cochlea through the housing to generate a sound; an air conduction vibrator, configured to generate an air conduction sound wave, the air conduction sound wave being transmitted to an ear of a user through a sound guiding hole on the housing; a processing circuit, configured to: provide a first audio signal to the bone conduction vibrator and a second audio signal to the air conduction vibrator. The processing circuit is further configured to: adjust a low-frequency component in the first audio signal or adjust a high-frequency component in the second audio signal.

### BRIEF DESCRIPTION OF THE DRAWINGS

The present disclosure will be further illustrated by way of exemplary embodiments. These exemplary embodiments will be described in detail with reference to the drawings. These embodiments are non-limiting. In these embodiments, the same numbers refer to the same structures, wherein:

FIG. 1 is a block diagram illustrating an exemplary acoustic output device according to some embodiments of the present disclosure;

FIG. 2 is a schematic diagram illustrating output curves of an exemplary acoustic output device according to some embodiments of the present disclosure;

FIG. 3 is a block diagram illustrating an exemplary processing circuit according to some embodiments of the present disclosure;

FIG. 4 is a schematic diagram illustrating an acoustic output device according to some embodiments of the present disclosure;

FIG. 5 is a schematic diagram illustrating a structure of a connection portion between a core assembly and an ear hook assembly according to some embodiments of the present disclosure;

FIG. 6 is an exploded schematic diagram illustrating a structure of the core assembly in FIG. 5;

FIG. 7 is a schematic diagram illustrating frequency response curves and phase curves of a bone conduction vibrator and an air conduction vibrator according to some embodiments of the present disclosure;

FIG. 8 is a schematic diagram illustrating frequency response curves and phase curves of sound signals output from two sound guiding holes coupled to front and rear cavities of an air conduction vibrator according to some embodiments of the present disclosure;

FIG. 9 is a schematic diagram illustrating second audio signal curves obtained after low-pass filtering of different orders according to some embodiments of the present disclosure;

FIG. 10 is a schematic diagram illustrating sound leakage curves obtained after filtering of different orders according to some embodiments of the present disclosure;

FIG. 11 is a schematic diagram illustrating input signal curves obtained after high-pass filtering of different orders according to some embodiments of the present disclosure; and

FIG. 12 is a schematic diagram illustrating first audio signal curves obtained after high-pass filtering of different orders according to some embodiments of the present disclosure.

### DETAILED DESCRIPTION

To more clearly illustrate the technical solutions of the embodiments of the present disclosure, the accompanying drawings used in the description of the embodiments will be briefly introduced below. Obviously, the accompanying drawings in the following description are merely some examples or embodiments of the present disclosure. For a person of ordinary skill in the art, the present disclosure can be applied to other similar scenarios based on these accompanying drawings without creative effort. It should be understood that these exemplary embodiments are provided only to enable a person skilled in the relevant art to better understand and implement the present disclosure, and are not intended to limit the scope of the present disclosure in any way. Unless obviously obtained from the context or the context illustrates otherwise, the same numeral in the drawings refers to the same structure or operation.

As shown in the present disclosure and the claims, unless the context clearly indicates an exception, the terms “a”, “an”, “one”, and/or “the” are not limited to the singular form and may include the plural form. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements. The term “based on” is “based at least in part on.” The term “one embodiment” means “at least one embodiment”; the term “another embodiment” means “at least one other embodiment”.

In the description of the present disclosure, it should be understood that the orientation or positional relationships indicated by terms such as “front”, “rear”, “ear hook”, and “rear hook” are based on the orientation or positional relationships shown in the accompanying drawings. These terms are used only to facilitate the description of the present disclosure and simplify the description, and do not indicate or imply that the referred device or element must have a specific orientation or be constructed and operated in a specific orientation. Therefore, these terms should not be construed as limiting the present disclosure.

Furthermore, the terms “first” and “second” are used for descriptive purposes only, and should not be construed as indicating or implying relative importance or implicitly specifying the quantity of the indicated technical features. Thus, features defined with “first” and “second” may explicitly or implicitly include at least one of the features. In the description of the present disclosure, the meaning of “a plurality of” is at least two, for example, two, three, etc., unless otherwise explicitly and specifically limited.

In the present disclosure, unless otherwise explicitly specified and limited, terms such as “install”, “connect”, “link”, and “fix” should be understood broadly. For example, the connection may be a fixed connection or a detachable connection. The connection may be an integral connection. The connection may be a mechanical connection or an electrical connection. The connection may be a direct connection or an indirect connection through an intermediate medium. The connection may be an internal communication between two elements or an interaction relationship between two elements, unless otherwise explicitly limited. For a person of ordinary skill in the art, the specific meanings of the above terms in the present disclosure can be understood according to specific situations.

Some embodiments of the present disclosure provide an acoustic output device. By adjusting a low-frequency component in a first audio signal or a high-frequency component in a second audio signal via a processing circuit, proportions of a bone conduction component and an air conduction component in an output of the acoustic output device are variable, thereby adjusting high-frequency and low-frequency output effects of the acoustic output device, so that the acoustic output device is suitable for different scenarios, and the user experience of the acoustic output device is improved. In some embodiments, based on various information such as an input of a user, environmental information of the user, and sound content listened to by the user, adjustments of the bone conduction component and air conduction component in the output of the acoustic output device may be achieved through various manners such as changing a crossover frequency and changing a filter order, thereby providing a better auditory experience for the user.

Some embodiments of the present disclosure provide an acoustic output device. The acoustic output device may provide a first audio signal to a bone conduction vibrator and a second audio signal to an air conduction vibrator via a processing circuit based on a variable crossover frequency. By setting the crossover frequency to be variable, the proportions of the bone conduction component and air conduction component in the output of the acoustic output device are variable, thereby adjusting the output effect of the acoustic output device, so that the acoustic output device is suitable for different scenarios, and the user experience of the acoustic output device is improved.

Other embodiments of the present disclosure provide an acoustic output device. The acoustic output device performs filtering on an electrical signal containing audio information by setting an order of high-pass filtering or an order of low-pass filtering to be variable to obtain a first audio signal and a second audio signal. By setting the order of the high-pass filtering or the order of the low-pass filtering to be variable to adjust the high-frequency and low-frequency output effects of the acoustic output device, the acoustic output device is suitable for different scenarios, and the user experience of the acoustic output device is improved.

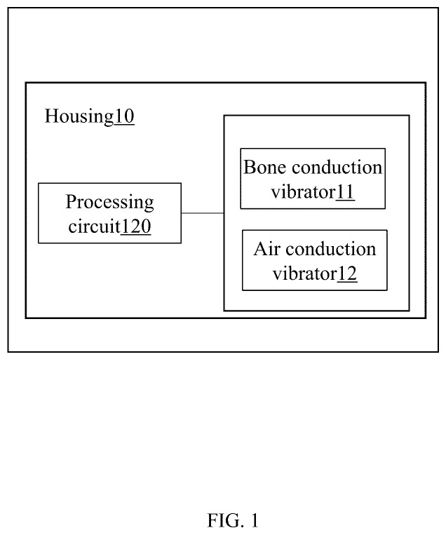

FIG. 1 is a block diagram illustrating an exemplary acoustic output device according to some embodiments of the present disclosure.

In some embodiments, an acoustic output device 100 may include a housing 10, a bone conduction vibrator 11, an air conduction vibrator 12, and a processing circuit 120. The housing 10 serves as a main body and provides an installation and fixation platform for other components (e.g., the bone conduction vibrator 11, the air conduction vibrator 12, the processing circuit 120, etc.). The bone conduction vibrator 11, the air conduction vibrator 12, and the processing circuit 120 may all be disposed within the housing 10. The bone conduction vibrator 11 is configured to generate a bone conduction sound wave for a user. The air conduction vibrator 12 is configured to generate an air conduction sound wave for the user. The processing circuit 120 is configured to provide a first audio signal to the bone conduction vibrator 11 and provide a second audio signal to the air conduction vibrator 12.

In some embodiments, the first audio signal and the second audio signal have a crossover frequency. The first audio signal may mainly include signals with a frequency component above the crossover frequency. The second audio signal may mainly include signals with a frequency component lower than the crossover frequency. For convenience of description, the signal with a frequency component above the crossover frequency is hereinafter referred to as a “high-frequency component” or a “high-frequency signal”. The signal with a frequency component lower than the crossover frequency is hereinafter referred to as a “low-frequency component” or a “low-frequency signal”.

The bone conduction vibrator 11 refers to a vibration element that generates a sound through vibration conduction via a solid medium (e.g., bone). In some embodiments, the bone conduction vibrator 11 may be configured to mainly generate high-frequency bone conduction sound waves with a frequency above the crossover frequency. In a wearing state, a bone conduction sound wave is transmitted to a cochlea of the user through the housing 10 to generate a sound. The bone conduction sound wave refers to a sound wave transmitted in the form of mechanical vibration through the solid medium (e.g., the bone). The frequency above the crossover frequency refers to a frequency greater than the crossover frequency.

The air conduction vibrator 12 refers to a vibration element that generates a sound through vibration conduction via air. In some embodiments, the air conduction vibrator 12 may be configured to mainly generate low-frequency air conduction sound waves with a frequency below the crossover frequency. An air conduction sound wave is transmitted to an ear of the user through a sound guiding hole on the housing 10. The air conduction sound wave refers to a sound wave transmitted in the form of mechanical vibration through air. More descriptions regarding the housing 10 and the sound guiding hole may be found in the related descriptions below. The frequency below the crossover frequency refers to a frequency less than the crossover frequency.

The processing circuit 120 refers to a circuit element that processes signals. In some embodiments, the processing circuit 120 is configured to provide the first audio signal to the bone conduction vibrator 11 and provide the second audio signal to the air conduction vibrator 12. In some embodiments, the processing circuit 120 may obtain a high-frequency first audio signal by performing high-pass filtering on an original audio signal, and obtain a low-frequency second audio signal by performing low-pass filtering on the original audio signal. The original audio signal refers to an electrical signal containing audio information. In some embodiments, the original audio signal may include an audio signal stored internally in the acoustic output device 100, an audio signal from a device communicatively connected to the external environment, etc. For example, the original audio signal may include electrical signals obtained from a multimedia platform, a terminal device, a storage device, etc. In some embodiments, the processing circuit 120 may be further configured to adjust the low-frequency component in the first audio signal or adjust the high-frequency component in the second audio signal, thereby adjusting high-frequency and low-frequency output effects of the acoustic output device 100, so that the acoustic output device 100 is suitable for different scenarios, and the user experience of the acoustic output device 100 is improved. In some embodiments, the processing circuit 120 may provide the first audio signal to the bone conduction vibrator 11 and provide the second audio signal to the air conduction vibrator 12 based on the crossover frequency.

The first audio signal refers to an input signal of the bone conduction vibrator 11. In some embodiments, the first audio signal includes components whose frequencies above the crossover frequency.

The second audio signal refers to an input signal of the air conduction vibrator 12. In some embodiments, the second audio signal may include components whose frequencies below the crossover frequency.

For ease of understanding, the crossover frequency refers to an intersection in a frequency domain between the first audio signal input to the bone conduction vibrator 11 and the second audio signal input to the air conduction vibrator 12 after processing by the processing circuit 120.

In some embodiments, the crossover frequency may be measured through a following operation. The following operation includes connecting leads that are in parallel to an input end of the bone conduction vibrator 11 and an input end of the air conduction vibrator 12 from an output end of the processing circuit 120, recording two sets of electrical signals using a sound card and Audition software, converting the two sets of electrical signals to the frequency domain, and determining an intersection of curves corresponding to the two sets of electrical signals in the frequency domain as the crossover frequency.

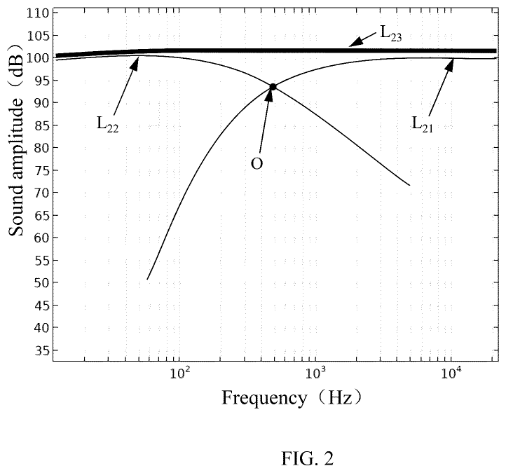

FIG. 2 is a schematic diagram illustrating output curves of an exemplary acoustic output device according to some embodiments of the present disclosure. A horizontal coordinate is frequency, and a vertical coordinate is sound pressure level. A curve L₂₁ is a frequency response curve corresponding to the first audio signal, a curve L₂₂ is a frequency response curve corresponding to the second audio signal, a curve L₂₃ is a frequency response curve corresponding to an original audio signal, and an intersection O between the curve L₂₁ and the curve L₂₂ is a crossover frequency between the first audio signal and the second audio signal. In some embodiments, the processing circuit 120 may obtain the first audio signal by performing high-pass filtering on the original audio signal, and obtain the second audio signal by performing low-pass filtering on the original audio signal.

In some embodiments, the crossover frequency may serve as a cutoff frequency of the high-pass filtering or the low-pass filtering. After the original audio signal undergoes the low-pass filtering, a portion above the cutoff frequency is filtered out, thereby mainly retaining a low-frequency component below the cutoff frequency. Similarly, after the original audio signal undergoes the high-pass filtering, a portion below the cutoff frequency is filtered out, thereby mainly retaining a high-frequency component above the cutoff frequency. In some variable embodiments, the cutoff frequency of the low-pass filtering may be higher than the crossover frequency, and the cutoff frequency of the high-pass filtering may be lower than the crossover frequency. In some embodiments, the cutoff frequency of the low-pass filtering may be less than the cutoff frequency of the high-pass filtering. In this case, frequency components of the first audio signal and the second audio signal may overlap or not overlap with each other. In some embodiments, the cutoff frequency of the low-pass filtering may also be greater than the cutoff frequency of the high-pass filtering. In this case, the frequency components of the first audio signal and the second audio signal overlap with each other. In some embodiments, the crossover frequency may serve as the cutoff frequency of the high-pass filtering and the low-pass filtering. In this case, the cutoff frequency of the low-pass filtering is the same as the cutoff frequency of the high-pass filtering, and the frequency components of the first audio signal and the second audio signal overlap with each other.

In some embodiments, the crossover frequency is variable, so that the proportions of the bone conduction component and the air conduction component in the output of the acoustic output device 100 are variable, thereby adjusting the output effect of the acoustic output device 100, so that the acoustic output device 100 is suitable for different scenarios (e.g., a game scenario where vibration enhances immersion, a call scenario with good sound listening effect, a noise reduction scenario with less sound leakage, etc.), and the user experience of the acoustic output device 100 is improved.

For example, when the user is in a quiet environment (e.g., a library, an exhibition hall, etc.) and has a high requirement for sound leakage reduction, the crossover frequency may be set relatively low to reduce an output of the air conduction vibrator 12 within a high frequency range, so that the acoustic output device 100 outputs relatively few air conduction sound waves within the high frequency range, and sound leakage of the acoustic output device 100 is not obvious. As another example, when the user is in a noisy environment, the requirement for sound leakage reduction is low, while the requirement for an output volume of the acoustic output device 100 is high. Taking into consideration the high vibration power consumption of the bone conduction vibrator 11, the crossover frequency may be set relatively high so that the air conduction vibrator 12 may output a louder air conduction sound within the high frequency range.

In some embodiments, an order of the high-pass filtering or an order of the low-pass filtering is variable, so as to adjust a low-frequency component in the first audio signal or adjust a high-frequency component in the second audio signal, thereby adjusting the output effect of the acoustic output device 100, so that the acoustic output device 100 is suitable for different scenarios, and the user experience of the acoustic output device 100 is improved.

In some embodiments, a cutoff frequency of an element used by the acoustic output device 100 for the high-pass filtering and the low-pass filtering is variable, so as to correspond to the variable crossover frequency. In some embodiments, the acoustic output device 100 may have a plurality of elements used for the high-pass filtering and the low-pass filtering. A cutoff frequency corresponding to each of the plurality of elements may be different. The acoustic output device 100 may select a corresponding element to perform working filtering according to an adjusted crossover frequency. In some embodiments, the implementation manner for achieving a variable filtering order may be the same as the implementation manner for achieving a variable cutoff frequency described above, and details are not repeated herein.

In some embodiments, the acoustic output device 100 may adjust the crossover frequency based on a specific scenario.

The specific scenario refers to a special scenario in which the user uses the acoustic output device 100. For example, the specific scenario may include a game scenario, a call scenario, a noise reduction scenario (referring to a scenario where noise reduction is required, e.g., a library scenario), etc.

For example, when the specific scenario is a game scenario or a movie scenario, the acoustic output device 100 may lower the crossover frequency, so that the bone conduction vibrator 11 may generate more low-frequency vibrations. When the acoustic output device 100 outputs a specific sound (e.g., a gunshot, a thunder, or the like in a playback file such as a game, a video, or an audio file), the acoustic output device 100 may generate an obvious vibration sensation to stimulate or prompt the user, thereby improving the user experience. Merely by way of example, in a shooting game, the acoustic output device 100 may lower the crossover frequency, so that when the acoustic output device 100 outputs a gunshot, a corresponding vibration may be generated to prompt the user. Furthermore, based on gunshots from different directions (e.g., front right, etc.), the acoustic output device 100 at a corresponding wearing position of the user (e.g., the right ear, etc.) may generate a vibration to prompt the user of a direction of an enemy, thereby improving the immersive experience of the user.

As another example, when the specific scenario is a call scenario, the acoustic output device 100 may increase the crossover frequency, reduce bone conduction sound waves generated by the bone conduction vibrator 11 within a low frequency range, so as to attenuate a vibration sensation of the acoustic output device 100 within the low frequency range, thereby improving user comfort. At the same time, setting the crossover frequency higher may also increase a proportion of air conduction sound waves in the sound. Since an air load pushed by the air conduction vibrator 12 is small, while a load of the bone conduction vibrator 11 when generating a low-frequency vibration is large, by increasing the crossover frequency, a power consumption may be effectively reduced, thereby ensuring that the acoustic output device 100 has a long battery life at a larger volume.

As another example, when the specific scenario is a noise reduction scenario, the acoustic output device 100 may lower the crossover frequency, so that the air conduction vibrator 12 mainly produces sounds within the low frequency range, reduces an output of the air conduction vibrator 12 within the high frequency range, so that the acoustic output device 100 outputs fewer air conduction sound waves within the high frequency range, and sound leakage of the acoustic output device 100 is not obvious.

In some embodiments, the acoustic output device 100 may adjust the crossover frequency through the processing circuit 120.

In some embodiments, the processing circuit 120 may be further configured to receive a trigger signal, and adjust the low-frequency component in the first audio signal or adjust the high-frequency component in the second audio signal based on the trigger signal.

In some embodiments, the processing circuit 120 may adjust the low-frequency component in the first audio signal or adjust the high-frequency component in the second audio signal based on the trigger signal by means of table lookup, a preset rule, etc. For example, the table may include different trigger signals and corresponding adjustment values of the low-frequency component in the first audio signal or corresponding adjustment values of the high-frequency component in the second audio signal. The processing circuit may directly determine an adjustment result by table lookup. As another example, the preset rule may be determined based on experience or requirements. An exemplary preset rule may be that when the trigger signal is for a specific game scenario, the low-frequency component in the first audio signal is increased by a %. The processing circuit may directly determine the adjustment result through the preset rule.

By configuring the processing circuit 120 to receive the trigger signal and adjust the low-frequency component in the first audio signal or adjust the high-frequency component in the second audio signal based on the trigger signal, proportions of high-frequency and low-frequency components of the bone conduction output and the air conduction output can be adaptively adjusted according to the trigger signal, so that the acoustic output device 100 is suitable for different scenarios, thereby improving the user experience.

In some embodiments, adjusting the low-frequency component in the first audio signal includes: enhancing the low-frequency component with a frequency below the crossover frequency in the first audio signal. By enhancing the low-frequency component with a frequency below the crossover frequency in the first audio signal, a mid-to-low frequency vibration sensation of bone conduction can be enhanced, thereby providing a better user experience in specific scenarios (e.g., a shooting game in a gaming environment).

In some embodiments, enhancing the low-frequency component with a frequency below the crossover frequency in the first audio signal includes lowering the crossover frequency. Merely by way of example, a first crossover frequency is lowered to a second crossover frequency. For a low-frequency component in a frequency band between the second crossover frequency and the first crossover frequency (i.e., the low-frequency component below the first crossover frequency and above the second crossover frequency), before adjustment (corresponding to the first crossover frequency), the low-frequency component may be removed by the high-pass filtering; after the adjustment (corresponding to the second crossover frequency), the low-frequency component may be retained by the high-pass filtering. That is, by lowering the first crossover frequency to the second crossover frequency, more low-frequency components with a frequency below the first crossover frequency may be included in the first audio signal, thereby achieving enhancement of the low-frequency component with a frequency below the first crossover frequency in the first audio signal.

In some embodiments, the first audio signal is obtained by the processing circuit performing high-pass filtering on an electrical signal containing audio information. Enhancing the low-frequency component with a frequency below the crossover frequency in the first audio signal includes lowering the order of the high-pass filtering. A lower order of a high-pass filter results in a poorer high-pass filtering effect on the original audio signal and more low-frequency components with a frequency below the crossover frequency in the first audio signal, thereby achieving the enhancement of the low-frequency component with a frequency below the crossover frequency in the first audio signal.

In some embodiments, enhancing the low-frequency component with a frequency below the crossover frequency in the first audio signal may include: merging the second audio signal into the first audio signal, so as to supplement and enhance the low-frequency component with a frequency below the crossover frequency in the first audio signal with the second audio signal; or, directly providing the original audio signal to the bone conduction vibrator 11. In some embodiments, directly providing the original audio signal to the bone conduction vibrator 11 may be equivalent to setting the order of the high-pass filtering to zero.

In some embodiments, the processing circuit may also attenuate the low-frequency component with a frequency below the crossover frequency in the first audio signal. For example, when the specific scenario is a call scenario, by increasing the crossover frequency, increasing the order of the high-pass filtering, etc., the low-frequency component with a frequency below the crossover frequency in the first audio signal is attenuated, so that the bone conduction vibrator 11 mainly produces sounds within the high frequency range, the low-frequency vibration is reduced, thereby improving the user experience.

Merely by way of example, a first crossover frequency is increased to a second crossover frequency. For a low-frequency component in a frequency band between the first crossover frequency and the second crossover frequency (i.e., the low-frequency component above the first crossover frequency and below the second crossover frequency), before adjustment (corresponding to the first crossover frequency), the low-frequency component may be retained by the high-pass filtering; after the adjustment (corresponding to the second crossover frequency), the low-frequency component may be removed by the high-pass filtering. That is, by increasing the first crossover frequency to the second crossover frequency, fewer low-frequency components with a frequency below the second crossover frequency may be included in the first audio signal, thereby achieving the attenuation of the low-frequency component with a frequency below the second crossover frequency in the first audio signal.

The higher the order of the high-pass filter, the better the high-pass filtering effect on the original audio signal, and fewer low-frequency components with a frequency below the crossover frequency may be included in the first audio signal, thereby achieving the attenuation of the low-frequency component with a frequency below the crossover frequency in the first audio signal.

In some embodiments, adjusting the high-frequency component in the second audio signal includes: attenuating the high-frequency component with a frequency above the crossover frequency in the second audio signal. By attenuating the high-frequency component with a frequency above the crossover frequency in the second audio signal, the air conduction sound waves output by the air conduction vibrator 12 within a mid-to-high frequency range can be reduced, thereby avoiding an increase in sound leakage caused by failure of a dipole mechanism in a high-frequency band, and providing a better user experience in specific scenarios (e.g., the call scenario, etc.).

In some embodiments, attenuating the high-frequency component in the second audio signal with a frequency above the crossover frequency includes: lowering the crossover frequency. Merely by way of example, a first crossover frequency is lowered to a second crossover frequency. For a high-frequency component in a frequency band between the second crossover frequency and the first crossover frequency (i.e., the high-frequency component below the first crossover frequency and above the second crossover frequency), before adjustment (corresponding to the first crossover frequency), the high-frequency component may be retained by the low-pass filtering, and after the adjustment (corresponding to the second crossover frequency), the high-frequency component may be removed by the low-pass filtering. That is, by lowering the first crossover frequency to the second crossover frequency, fewer high-frequency components with a frequency above the second crossover frequency may be included in the second audio signal, thereby achieving the attenuation of the high-frequency component with a frequency above the second crossover frequency in the second audio signal.

In some embodiments, the second audio signal is obtained by the processing circuit performing low-pass filtering on the electrical signal containing the audio information. Attenuating the high-frequency component with a frequency above the crossover frequency in the second audio signal includes: increasing the order of the low-pass filtering. The higher the order of the low-pass filtering, the better the low-pass filtering effect, and fewer high-frequency components with a frequency above the crossover frequency may be included in the second audio signal, thereby achieving the attenuation of the high-frequency component with a frequency above the crossover frequency in the second audio signal.

In some embodiments, the processing circuit may also enhance the high-frequency component with a frequency above the crossover frequency in the second audio signal. For example, when the specific scenario is a high-noise scenario, by lowering the order of the low-pass filtering, increasing the crossover frequency, or the like, a portion of the second audio signal with a frequency above the crossover frequency is enhanced, so that the high-frequency component of the air conduction vibrator increases, an output performance of the acoustic output device 100 is improved, and the power consumption of the acoustic output device 100 is reduced.

Merely by way of example, a first crossover frequency is increased to a second crossover frequency. For a high-frequency component in a frequency band between the second crossover frequency and the first crossover frequency (i.e., the high-frequency component above the first crossover frequency and below the second crossover frequency), before adjustment (corresponding to the first crossover frequency), the high-frequency component may be removed by the low-pass filtering, and after the adjustment (corresponding to the second crossover frequency), the high-frequency component may be retained by the low-pass filtering. That is, by increasing the first crossover frequency to the second crossover frequency, fewer high-frequency components with a frequency above the first crossover frequency may be included in the second audio signal, thereby achieving the attenuation of the high-frequency component with a frequency above the first crossover frequency in the second audio signal.

The lower the order of the low-pass filtering, the worse the low-pass filtering effect, and more high-frequency components with a frequency above the crossover frequency may be included in the second audio signal, thereby achieving the enhancement of the high-frequency component with a frequency above the crossover frequency in the second audio signal.

More descriptions regarding a process for adjusting the crossover frequency and the order of the filter (also referred to as the filter order) may be found in the related descriptions later.

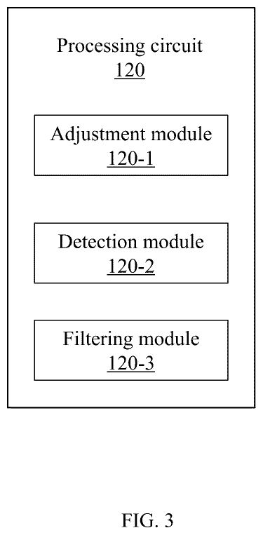

FIG. 3 is a block diagram illustrating an exemplary processing circuit according to some embodiments of the present disclosure. Referring to FIG. 3, in some embodiments, the processing circuit 120 may include an adjustment module 120-1, a detection module 120-2, and a filtering module 120-3. The adjustment module 120-1 is configured to identify a trigger signal and adjust a crossover frequency or a filter order. The detection module 120-2 is configured to detect an external input and generate the trigger signal. The filtering module 120-3 is configured to perform corresponding filtering on an original audio signal based on the crossover frequency and the filter order determined by the adjustment module 120-1.

In some embodiments, the trigger signal may be detected by the detection module 120-2 and input to the adjustment module 120-1. The trigger signal may include adjustment information of the crossover frequency or the filter order. The adjustment module 120-1 is configured to adjust the crossover frequency or the filter order correspondingly based on different trigger signals. In some embodiments, the trigger signal may directly include related adjustment information, and the adjustment module 120-1 may be configured to perform an adjustment directly according to the related adjustment information. In some embodiments, the trigger signal may not include specific adjustment information, and the adjustment module 120-1 may be configured to determine the adjustment information according to a preset correspondence. The preset correspondence may be pre-stored in the acoustic output device 100 (e.g., the adjustment module 120-1) or manually input.

In some embodiments, the trigger signal may be input by a user. That is, the detection module 120-2 may be configured to directly detect information input by the user (e.g., a specific operation instruction, or the like) to determine the trigger signal. According to a specific operation instruction input by the user (e.g., increasing or decreasing a volume, adjusting a working mode, or the like), the detection module 120-2 may be configured to generate a corresponding trigger signal, and the adjustment module 120-1 is configured to perform a corresponding adjustment after identifying the corresponding trigger signal. Merely by way of example, according to a specific working mode (e.g., a vibration sense mode, or the like) selected by the user, the acoustic output device 100 may be configured to enhance a low-frequency component in a first audio signal to enhance low-frequency vibration sense.

Correspondingly, trigger information may correspond to lowering the crossover frequency, and the processing circuit 120 (e.g., the adjustment module 120-1) may be configured to lower the crossover frequency. In some embodiments, an input manner of the specific operation instruction may include, but is not limited to, a button input, a specific gesture input (e.g., sliding, tapping, or the like), a voice input, etc.

In some embodiments, the trigger signal is obtained by recognizing audio content through the acoustic output device 100 (e.g., the detection module 120-2, or the like) or a processing device connected to the acoustic output device 100. In some embodiments, the acoustic output device 100 (e.g., the detection module 120-2, or the like) or the processing device connected to the acoustic output device 100 is configured to recognize the audio content through a machine learning model, an algorithm, or the like. In response to a recognition result of the audio content, the trigger signal is obtained. The audio content refers to related audio information output by the acoustic output device 100. The recognition result of the audio content refers to information data related to the audio content, for example, an audio type (e.g., a gunshot, or the like), an audio feature (e.g., a volume parameter, or the like), etc. Exemplarily, when the acoustic output device 100 (e.g., the detection module 120-2, or the like) or the processing device connected to the acoustic output device 100 recognizes that the audio type is a gunshot, the acoustic output device 100 may be configured to enhance the low-frequency component in the first audio signal to enhance the low-frequency vibration and provide a vibration sense for the user. Correspondingly, the trigger information may correspond to lowering the crossover frequency, and the processing circuit 120 (e.g., the adjustment module 120-1) is configured to lower the crossover frequency according to the trigger information.

In some embodiments, the trigger signal may be obtained by recognizing a surrounding environment through the acoustic output device 100 (e.g., the detection module 120-2) or the processing device connected to the acoustic output device 100. In some embodiments, the acoustic output device 100 (e.g., the detection module 120-2) or the processing device connected to the acoustic output device 100 is configured to recognize the surrounding environment through a machine learning model, an algorithm, or the like. In response to a recognition result of the surrounding environment satisfying a preset condition, the trigger signal is obtained. The surrounding environment refers to an environment where the user uses the acoustic output device 100. The recognition result of the surrounding environment refers to information data related to the surrounding environment. For example, the recognition result of the surrounding environment may be an environment type (e.g., a low-noise environment, or the like), etc. Exemplarily, when the acoustic output device 100 (e.g., the detection module 120-2, or the like) or the processing device connected to the acoustic output device 100 recognizes that the environment type is a low-noise environment, the acoustic output device 100 is configured to attenuate the high-frequency component in the second audio signal to reduce sound leakage. Correspondingly, the trigger information may correspond to lowering the crossover frequency, and the processing circuit 120 (e.g., the adjustment module 120-1) is configured to lower the crossover frequency according to the trigger information.

In some embodiments, the filtering module 120-3 may be configured to perform the filtering process on the original audio signal through hardware, software (algorithm), or a combination thereof. For example, the filtering module 120-3 may be configured to filter a certain signal through a circuit and/or an algorithm. In some embodiments, the hardware may include, but is not limited to, an equalizer (EQ), a dynamic range controller (DRC), a phase and gain processor (GAIN), etc.

In some embodiments, the original audio signal may be filtered in the filtering module 120-3, thereby obtaining the first audio signal and/or the second audio signal. The first audio signal and/or the second audio signal may include a specific frequency.

In some embodiments, one or more filters or filter groups are provided to process the original audio signal in the filtering module 120-3, so as to obtain one or both of the first audio signal and the second audio signal. Exemplary filters or filter groups may include, but are not limited to, an analog filter, a digital filter, a passive filter, an active filter, or the like, or a combination thereof. For example, the filtering module 120-3 includes a high-pass filter and a low-pass filter. The filtering module 120-3 may perform high-pass filtering on the original audio signal to obtain the first audio signal, and perform low-pass filtering on the original audio signal to obtain the second audio signal.

By adjusting related parameters through the processing circuit 120 (the filtering module 120-3), the crossover frequency or the filter order is variable, thereby adjusting the output effect of the acoustic output device 100, so that the acoustic output device 100 is suitable for different scenarios, and the user experience of the acoustic output device 100 is improved.

It is able to be understood that the bone conduction vibrator 11 and the air conduction vibrator 12 may be electrically coupled to the filtering module 120-3. The bone conduction vibrator 11 may generate a bone conduction sound wave in a specific frequency range (e.g., a high-frequency range) according to the first audio signal obtained by the filtering module 120-3.

The air conduction vibrator 12 may generate an air conduction sound wave in a specific frequency range (e.g., a low-frequency range) according to the second audio signal obtained by the filtering module 120-3. In some embodiments, the bone conduction vibrator 11 and the air conduction vibrator 12 are two independent functional devices, or two independent elements of a single device. As described herein, a first device is independent of a second device, indicating that the operation of the first/second device is not caused by the operation of the second/first device, or in other words, the operation of the first/second device is not a result of the operation of the second/first device. Taking the bone conduction vibrator 11 and the air conduction vibrator 12 as an example, the air conduction vibrator 12 is independent of the bone conduction vibrator 11 because each of the two vibrators is independently driven by an electrical signal to generate a sound wave.

In some embodiments, different frequency ranges may be determined according to actual requirements. For example, a low-frequency range (also referred to as low frequency) may range from 20 Hz to 150 Hz, a mid-frequency range (also referred to as mid frequency) may range from 150 Hz to 5 kHz, a high-frequency range (also referred to as high frequency) may range from 5 kHz to 20 kHz, a mid-low frequency range (also referred to as mid-low frequency) may range from 150 Hz to 500 Hz, and a mid-high frequency range (also referred to as mid-high frequency) may range from 500 Hz to 5 kHz. As another example, the low-frequency range may range from 20 Hz to 200 Hz, the mid-frequency range may range from 200 Hz to 3 kHz, the high-frequency range may range from 3 kHz to 20 kHz, the mid-low frequency range may range from 100 Hz to 1000 Hz, and the mid-high frequency range may range from 1000 Hz to 10 KHz. It should be noted that the values of the frequency ranges are for illustrative purposes only and are not limiting. The definitions of the above frequency ranges may vary according to different application scenarios and different classification criteria. For example, in some other application scenarios, the low-frequency range may range from 20 Hz to 80 Hz, the mid-frequency range may range from 160 Hz to 1280 Hz, the high-frequency range may range from 2560 Hz to 20 kHz, the mid-low frequency range may range from 80 Hz to 160 Hz, and the mid-high frequency range may range from 1280 Hz to 2560 Hz. Optionally, different frequency ranges may overlap or not overlap.

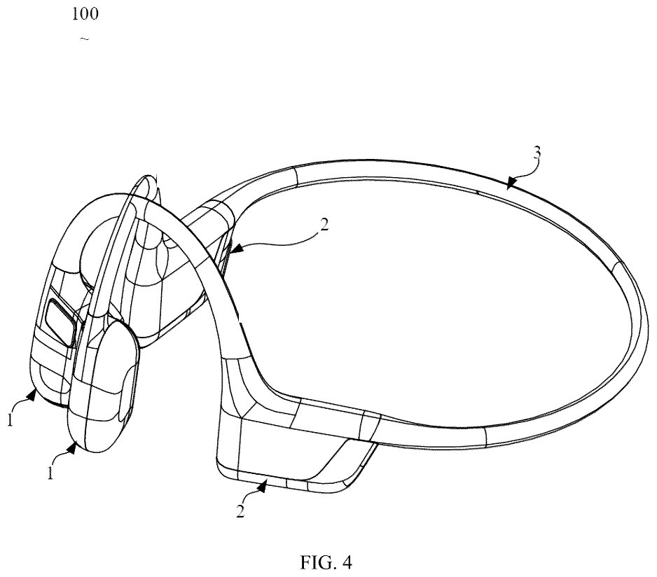

FIG. 4 is a schematic diagram illustrating an acoustic output device according to some embodiments of the present disclosure.

In some embodiments, as shown in FIG. 4, the acoustic output device 100 may include one or more core assemblies 1, one or more ear hook assemblies 2, and a rear hook assembly 3.

In some embodiments, a count of the one or more core assemblies 1 is two. The two core assemblies 1 are respectively configured to transmit vibrations and/or sounds to the left ear and the right ear of the user. The two core assemblies I may be the same or different. For example, one core assembly 1 may be provided with a microphone, while the other core assembly 1 may not be provided with a microphone. As another example, one core assembly 1 may be provided with a button and a corresponding circuit board, while the other core assembly 1 may not be provided with a button and a corresponding circuit board. The two core assemblies 1 may be the same in terms of a core module (e.g., a speaker module). The following descriptions of the present disclosure will take one of the two core assemblies 1 as an example for detailed descriptions.

In some embodiments, a count of the one or more ear hook assemblies 2 may be two. The two ear hook assemblies 2 may be respectively hooked on the left ear and the right ear of the user, so that the core assemblies 1 are able to fit against the face of the user. One ear hook assembly 2 may be provided with a battery, the other ear hook assembly 2 may be provided with a control circuit, etc. One end of each ear hook assembly 2 is connected to one core assembly 1, and the other end of the ear hook assembly 2 is connected to the rear hook assembly 3. The rear hook assembly 3 connects the two ear hook assemblies 2. The rear hook assembly 3 is configured to wrap around a rear side of the neck of the user or a rear side of the head of the user and may provide a clamping force, so that the two core assemblies 1 are clamped against two sides of the face of the user and the ear hook assemblies 2 are more stably hooked on the ear of the user.

In some embodiments, the acoustic output device 100 may not include the rear hook assembly 3. For example, the acoustic output device 100 may include one core assembly 1 and one ear hook assembly 2. One end of the ear hook assembly 2 may be connected to the core assembly 1, and the other end of the ear hook assembly 2 extends along a junction between the ear and the head of the user. In some embodiments, the ear hook assembly 2 may be an arc-shaped structure adapted to an auricle of the user, so that the ear hook assembly 2 is suspended on the auricle of the user. For example, the ear hook assembly 2 may be an arc-shaped structure adapted to a junction between the head and the ear of the user, so that the ear hook assembly 2 may be hooked between the auricle and the head of the user. In some embodiments, the ear hook assembly 2 may also be a clamping structure adapted to the auricle of the user, so that the ear hook assembly 2 may be clamped at the auricle of the user. For example, the ear hook assembly 2 may include a hook portion and a connection portion connected in sequence. The connection portion connects the hook portion and the core assembly 1, so that the acoustic output device 100 is curved in a three-dimensional space when the acoustic output device 100 is in a non-wearing state (i.e., a natural state). In other words, in the three-dimensional space, the hook portion, the connection portion, and the core assembly 1 are not coplanar. With such a configuration, when the acoustic output device 100 is in a wearing state, the hook portion may be mainly configured to hook between a rear side of the ear and the head of the user, and the core assembly 1 may be mainly configured for contacting a front side of the ear or the head of the user, thereby allowing the core assembly 1 and the hook portion to cooperate to clamp the ear. Merely by way of example, the connection portion may extend from the head toward an outer side of the head, thereby cooperating with the hook portion to provide a pressing force on the front side of the ear for the core assembly 1. Under an action of the pressing force, the core assembly 1 may specifically press against the user's skin, so that the acoustic output device 100 does not block an external auditory canal of the ear when the acoustic output device 100 is in the wearing state.

In some embodiments, the acoustic output device 100 may also not include the ear hook assembly 2 and the rear hook assembly 3, but include other fixing structures. The core assembly 1 is fixed on a fixing structure, so that the core assembly 1 fits against the ear, head, or other portions of the user through the fixing structure, so as to transmit an air conduction sound wave and/or a bone conduction sound wave output by the core assembly 1 to the user. For example, the fixing structure may be a head-mounted structure. The head-mounted structure connects the left and right core assemblies 1 to form a head-mounted acoustic output device. As another example, the fixing structure is a frame of glasses, and the core assembly is fixed on the frame of the glasses. As another example, the fixing structure may also be a structure such as a helmet, a mask, etc., which is not specifically limited herein.

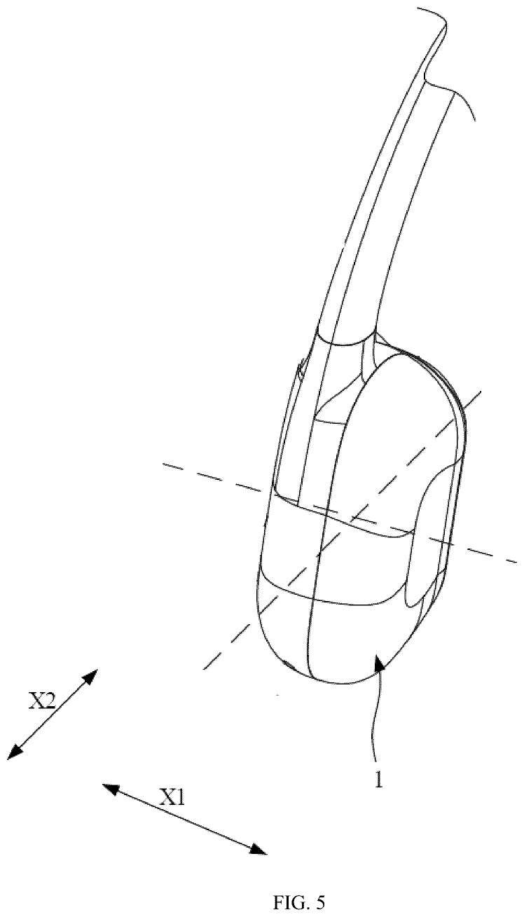

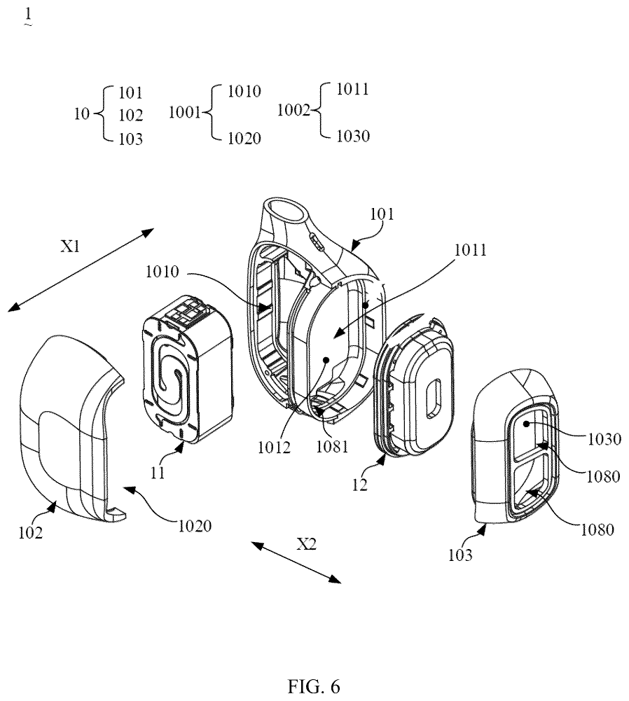

FIG. 5 is a schematic diagram illustrating a structure of a connection portion between a core assembly and an ear hook assembly according to some embodiments of the present disclosure. FIG. 6 is an exploded schematic diagram illustrating a structure of the core assembly in FIG. 5. As shown in FIG. 5 and FIG. 6, the core assembly 1 includes the housing 10, the bone conduction vibrator 11, and the air conduction vibrator 12.

In some embodiments, the housing 10 is provided with a first accommodating cavity 1001 and a second accommodating cavity 1002 that are isolated from each other. A sealing property of the first accommodating cavity 1001 is greater than a sealing property of the second accommodating cavity 1002. The bone conduction vibrator 11 is disposed in the first accommodating cavity 1001. The air conduction vibrator 12 is disposed in the second accommodating cavity 1002. The acoustic output device 100 operates through the bone conduction vibrator 11 and the air conduction vibrator 12 together. The air conduction vibrator 12 is configured to generate an air conduction sound wave, the air conduction sound wave is transmitted to the ear of the user through a sound guiding hole on the housing 10, so that the user receives an air conduction sound. The bone conduction vibrator 11 is configured to generate a bone conduction sound wave, the bone conduction sound wave is transmitted to a cochlea through the housing 10, thereby generating a bone conduction sound. In some embodiments, the first accommodating cavity 1001 is set as a completely sealed cavity, and the second accommodating cavity 1002 is set as a cavity with a relatively high sealing property under a condition of ensuring a sound production condition of the air conduction vibrator 12. Through the above arrangement, the bone conduction vibrator 11 and the air conduction vibrator 12 are independently disposed, which can effectively improve a sealing effect of the bone conduction vibrator 11, thereby preventing the bone conduction vibrator 11 from being eroded and damaged by external environmental factors, while ensuring a sound quality effect of the air conduction vibrator 12. In addition, When the bone conduction vibrator 11 and the air conduction vibrator 12 of the acoustic output device 100 operate simultaneously, the bone conduction vibrator 11 and the air conduction vibrator 12 are respectively disposed in the first accommodating cavity 1001 and the second accommodating cavity 1002, which can effectively prevent mutual interference between the bone conduction vibrator 11 and the air conduction vibrator 12, thereby effectively improving the sound quality of the acoustic output device 100.

In some embodiments, continuing to refer to FIG. 2 and FIG. 3, the housing 10 includes a first housing 101, a second housing 102, and a third housing 103. The first housing 101 and the second housing 102 cooperate with each other to form the first accommodating cavity 1001. The first housing 101 and/or the second housing 102 further form a portion of the second accommodating cavity 1002. The third housing 103 cooperates with the first housing 101 and/or the second housing 102 to form another portion of the second accommodating cavity 1002. In some embodiments, the housing 10 may be composed of the first housing 101, the second housing 102, and the third housing 103 cooperating with each other. The first housing 101 and the second housing 102 cooperate to form the first accommodating cavity 1001, the first housing 101 may be provided with a portion of the second accommodating cavity 1002. The third housing 103 and the first housing 101 cooperate with each other to form another portion of the second accommodating cavity 1002. The housing 10 is composed of the first housing 101, the second housing 102, and the third housing 103 cooperating with each other through the above structure, which can make the core assembly 1 structurally compact and also facilitate assembly of the core assembly 1, thereby improving an assembly efficiency of the core assembly 1. In some embodiments, a portion of the second accommodating cavity 1002 may also be disposed on the second housing 102. The third housing 103 and the second housing 102 cooperate with each other to form another portion of the second accommodating cavity 1002. Alternatively, the first housing 101 and the second housing 102 cooperate to form a portion of the second accommodating cavity 1002. The third housing 103 cooperates with the first housing 101 and the second housing 102 to form another portion of the second accommodating cavity 1002. The housing 10 implemented through any of the above embodiments is able to make the core assembly 1 structurally compact and also facilitate assembly of the core assembly 1, thereby improving the assembly efficiency of the core assembly 1.

In some embodiments, a partition wall 1012 for isolating the first accommodating cavity 1001 and the second accommodating cavity 1002 is disposed in the housing 10. In some embodiments, the partition wall 1012 may be disposed on the first housing 101 and/or the second housing 102. The first housing 101 and the second housing 102 cooperate with each other to form the first accommodating cavity 1001. The first housing 101 and/or the second housing 102 further form a portion of the second accommodating cavity 1002. The third housing 103 cooperates with the first housing 101 and/or the second housing 102 to form another portion of the second accommodating cavity 1002. The partition wall 1012 is disposed on the first housing 101 and/or the second housing 102 may be understood as the partition wall 1012 being a portion of the first housing 101 and/or the second housing 102. The first housing 101 and/or the second housing 102 further form a portion of the second accommodating cavity 1002. The third housing 103 cooperates with the first housing 101 and/or the second housing 102 to form another portion of the second accommodating cavity 1002. Certainly, the partition wall 1012 is not limited to being disposed on the first housing 101 and/or the second housing 102. In other embodiments, the partition wall 1012 may also be an independent member from the first housing 101 and/or the second housing 102. In some embodiments, the partition wall 1012 is disposed on the first housing 101, and the first housing 101 includes a first sub-accommodating cavity 1010 and a second sub-accommodating cavity 1011 located on opposite sides of the partition wall 1012. An opening direction of the first sub-accommodating cavity 1010 is arranged along a wall surface of the partition wall 1012, and an opening direction of the second sub-accommodating cavity 1011 is arranged to cross the wall surface of the partition wall 1012. The second housing 102 includes a third sub-accommodating cavity 1020. The second housing 102 covers an opening end of the first sub-accommodating cavity 1010. The third sub-accommodating cavity 1020 and the first sub-accommodating cavity 1010 cooperate to form the first accommodating cavity 1001. The third housing 103 includes a fourth sub-accommodating cavity 1030. The third housing 103 covers an opening end of the second sub-accommodating cavity 1011. The fourth sub-accommodating cavity 1030 and the second sub-accommodating cavity 1011 cooperate to form the second accommodating cavity 1002.

In some embodiments, a vibration direction of the bone conduction vibrator 11 and a vibration direction of the air conduction vibrator 12 are arranged to cross each other. The first housing 101 and the second housing 102 cooperate with each other along the vibration direction of the bone conduction vibrator 11. The third housing 103 cooperates with the first housing 101 and/or the second housing 102 along the vibration direction of the air conduction vibrator 12. In some embodiments, the vibration direction of the bone conduction vibrator 11 and the vibration direction of the air conduction vibrator 12 are arranged to cross each other. The vibration direction of the bone conduction vibrator 11 is hereinafter referred to as a first vibration direction X1. The vibration direction of the air conduction vibrator 12 may be referred to as a second vibration direction X2. The first vibration direction X1 and the second vibration direction X2 are not parallel to each other, but are arranged to cross each other. For example, the first vibration direction X1 and the second vibration direction X2 are perpendicular to each other or substantially perpendicular to each other (e.g.,) 90°+10°. When the bone conduction vibrator 11 and the air conduction vibrator 12 operate simultaneously, the bone conduction vibrator 11 and the air conduction vibrator 12 vibrate and operate along the first vibration direction X1 and the second vibration direction X2, respectively. Because the vibration directions of the bone conduction vibrator 11 and the air conduction vibrator 12 are arranged to cross each other, an impact of the vibration of the bone conduction vibrator 11 on sound quality of the air conduction vibrator 12 caused by vibrations in the same direction can be effectively alleviated. Furthermore, the first housing 101 and the second housing 102 are assembled to cooperate with each other along the first vibration direction X1. The third housing 103 and the first housing 101 are assembled to cooperate with each other along the second vibration direction X2. For example, the second accommodating cavity 1002 may be formed solely by the cooperation of the first housing 101 and the third housing 103. The third housing 103 only has a cooperative relationship with the first housing 101 along the second vibration direction X2. Similarly, in other embodiments of the housing 10, the third housing 103 may have a cooperative relationship along the second vibration direction X2 with a housing participating in forming the second accommodating cavity 1002. The arrangement herein facilitates assembly of the core assembly 1, thereby improving the assembly efficiency of the core assembly 1.

It should be noted that the foregoing FIG. 4 to FIG. 6 are merely exemplary illustrations of some embodiments of the acoustic output device 100 and are not limiting. The acoustic output device 100 may also adopt other forms having an acoustic output function, including but not limited to acoustic glasses, over-ear headphones, open-ear headphones, etc.

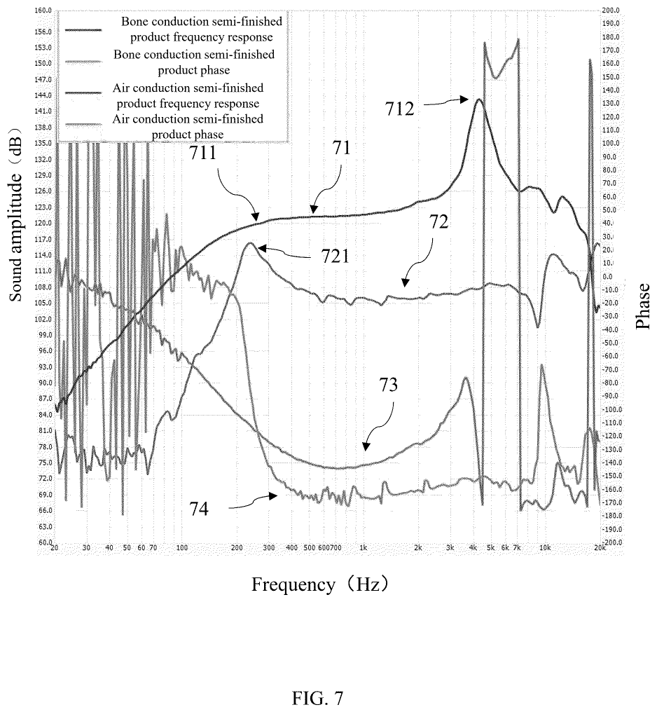

FIG. 7 is a schematic diagram illustrating frequency response curves and phase curves of a bone conduction vibrator and an air conduction vibrator according to some embodiments of the present disclosure. A curve 71 is a frequency response curve of the air conduction vibrator 12, and a curve 73 is a phase curve of the air conduction vibrator 12. A curve 72 is a frequency response curve of the bone conduction vibrator 11, and a curve 74 is a phase curve of the bone conduction vibrator 11. As shown in FIG. 7, the bone conduction vibrator 11 has a first resonance peak 721 at a first resonance frequency (e.g., 250 Hz). A first high-frequency resonance peak of the bone conduction vibrator 11 is located above 7000 Hz. The air conduction vibrator 12 has a second resonance peak 711 at a second resonance frequency (e.g., 300 Hz). The air conduction vibrator 12 has a third resonance peak 712 (i.e., a first high-frequency resonance peak of the air conduction vibrator 12) at a third resonance frequency (e.g., 4200 Hz).

In some embodiments, the first resonance frequency corresponds to a resonance frequency of the bone conduction vibrator 11. The second resonance frequency corresponds to a resonance frequency of the air conduction vibrator 12. Referring to FIG. 6, the air conduction vibrator 12 is disposed in the second accommodating cavity 1002. A first sound guiding hole 1080 and a second sound guiding hole 1081 are in communication with the second accommodating cavity 1002 to an external environment. In some embodiments, the air conduction vibrator 12 includes a diaphragm. The diaphragm divides the second accommodating cavity 1002 into a rear cavity and/or a front cavity located on opposite sides of the diaphragm. The rear cavity is located on a side of the diaphragm away from the partition wall 1012. The front cavity is located between the diaphragm and the partition wall 1012. The first sound guiding hole 1080 is in communication with the rear cavity, and the second sound guiding hole is in communication with the front cavity. When the diaphragm vibrates along the air conduction vibration direction X2, the front cavity may release pressure through the second sound guiding hole 1081. The front cavity or the rear cavity may form the third resonance peak 712 having the third resonance frequency.

As shown in FIG. 7, in the frequency response curve 72 of the bone conduction vibrator 11, a phase of a bone conduction signal corresponding to a frequency range between the first resonance peak 721 and the corresponding first high-frequency resonance peak is relatively stable. In the frequency response curve 71 of the air conduction vibrator 12, a phase of an air conduction signal corresponding to a frequency range between the second resonance peak 711 and the third resonance peak 712 (the corresponding first high-frequency resonance peak) is relatively stable.

In some embodiments, to cause a bone conduction sound wave and an air conduction sound wave generated by the acoustic output device 100 in a frequency band near a crossover frequency to mutually superimpose and enhance at the user's cochlea, phases of the bone conduction sound wave and the air conduction sound wave in the frequency band need to be the same or substantially the same. In this case, a crossover frequency of a first audio signal and a second audio signal may be set within a frequency band corresponding to a stable-phase region of the frequency responses of the bone conduction vibrator 11 and the air conduction vibrator 12, thereby enabling the bone conduction sound wave and the air conduction sound wave to superimpose in phase at the user's cochlea, improving the sound effect for the user. In some embodiments, the crossover frequency may be not less than the first resonance frequency and the second resonance frequency. That is, the crossover frequency may be not less than a larger one of the first resonance frequency and the second resonance frequency. For example, the crossover frequency may be not less than 300 Hz. Furthermore, the crossover frequency may not be greater than the first high-frequency resonance frequency of the bone conduction vibrator 11 and the first high-frequency resonance frequency of the air conduction vibrator 12 (i.e., the third resonance frequency). That is, the crossover frequency may not be greater than a smaller one of the first high-frequency resonance frequency of the bone conduction vibrator 11 and the first high-frequency resonance frequency of the air conduction vibrator 12 (i.e., the third resonance frequency). For example, the crossover frequency may not be greater than 4200 Hz.

As shown in FIG. 7, the vibration of the bone conduction vibrator 11 in a frequency range near a resonance frequency (the first resonance frequency, e.g., 250 Hz) of the bone conduction vibrator 11 brings a strong vibration sensation to the user's face. As the frequency of the bone conduction sound wave output by the bone conduction vibrator 11 increases, the vibration sensation brought by the bone conduction vibrator 11 to the user's face gradually attenuates. For example, the bone conduction vibrator 11 may produce a strong vibration sensation (e.g., a slapping sensation) in a range of 150 Hz-300 Hz, produce a weaker vibration sensation (e.g., a tingling sensation) in a range of 300 Hz-400 Hz, and produce a relatively slight vibration sensation in a range of 400 Hz-600 Hz. If the crossover frequency is set too low, the first audio signal may include a frequency range near the first resonance frequency, and the bone conduction vibrator 11 may produce more low-frequency vibrations. In this case, even if an order of a high-pass filter is increased, the effect is extremely limited (many low-frequency vibrations still exist above a cutoff point, i.e., the crossover frequency). Therefore, to avoid the resonance peak of the bone conduction vibrator 11, a bone conduction output range may not be less than the first resonance frequency, and a corresponding crossover frequency may not be less than the first resonance frequency (e.g., 250 Hz). This avoids outputting frequencies of the bone conduction vibrator 11 that are too low to cause the bone conduction vibrator 11 to produce excessively strong vibration sensations, which may provide a poor user experience.

As shown in FIG. 7, for the frequency response curve 71 of the air conduction vibrator 12, a portion between the second resonance peak 711 and the third resonance peak 712 is relatively flat. To ensure a stable output of the air conduction vibrator 12, an output range of the air conduction vibrator 12 may not be less than the second resonance frequency (e.g., 300 Hz) to guarantee the output performance of the air conduction vibrator 12.

In some embodiments, to enable the air conduction vibrator 12 to have good output performance while avoiding the bone conduction vibrator 11 from producing excessive low-frequency vibrations, the crossover frequency may not be less than 300 Hz. In some embodiments, to further reduce the vibration sensation produced by the bone conduction vibrator 11, the crossover frequency may not be less than 350 Hz. In some embodiments, to further ensure the output performance of the air conduction vibrator 12, the crossover frequency may be not less than 400 Hz.

In some embodiments of the present disclosure, by setting the crossover frequency to not be less than 300 Hz, production of more low-frequency vibrations by the bone conduction vibrator is avoided, thereby preventing excessively strong vibration sensations that would lead to poor user experience, and ensuring low-frequency performance of the acoustic output device.

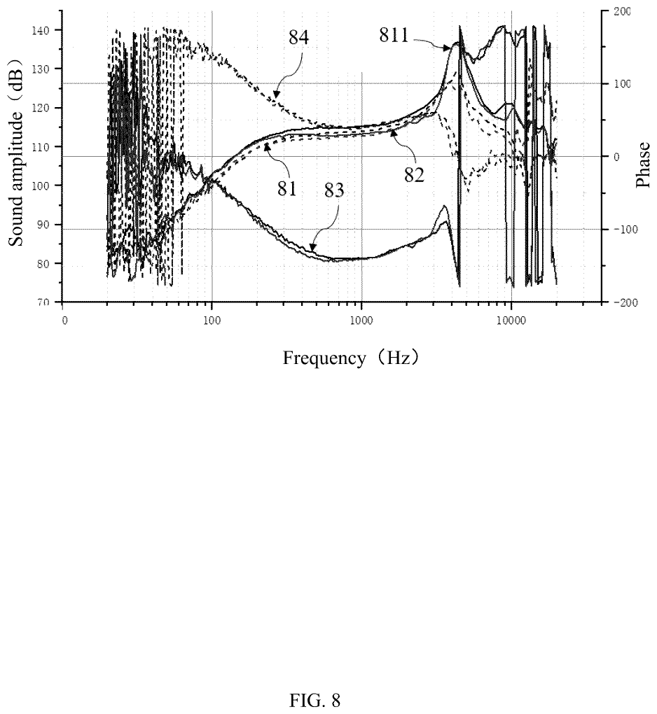

FIG. 8 is a schematic diagram illustrating frequency response curves and phase curves of sound signals output from two sound guiding holes coupled to front and rear cavities of an air conduction vibrator according to some embodiments of the present disclosure.

Referring to FIG. 8, a curve 81 is a frequency response curve of a first sound guiding hole, and a curve 83 is a phase curve of the first sound guiding hole. A curve 82 is a frequency response curve of a second sound guiding hole, and a curve 84 is a phase curve of the second sound guiding hole. As shown in FIG. 8, amplitude values of the frequency response curves (corresponding to curves 81 and 82) of the two sound guiding holes are substantially the same. An amplitude deviation of the frequency response curves of the two sound guiding holes is approximately +6 dB. A phase difference between the two sound guiding holes is 180° (or close to) 180°. After a third resonance peak 811 corresponding to a third resonance frequency, vibration modes on the frequency response curves 81, 82 increase. Correspondingly, phase jumps occur frequently, and the two sound guiding holes are unable to stably maintain a phase difference of 180° (or close to) 180°, thereby causing a sound leakage reduction mechanism to fail. This leads to a deterioration in a dipole effect formed by the air conduction vibrator via the two sound guiding holes, failing to effectively reduce sound leakage. On the other hand, as shown in FIG. 7, for the frequency response curve 71 of the air conduction vibrator 12, the portion between the second resonance peak 711 and the third resonance peak 712 is relatively flat. Therefore, in some embodiments, considering the above factors comprehensively, to make the crossover frequency avoid a frequency band where the air conduction vibrator 12 has complex vibration modes, and to enable the air conduction vibrator 12 to have good output performance, an output range of the air conduction vibrator 12 may not be higher than the third resonance frequency (e.g., 4200 Hz). That is, the crossover frequency may not be higher than the third resonance frequency (e.g., 4200 Hz).

In some embodiments, to ensure the sound leakage reduction effect and the output performance of the air conduction vibrator 12, the crossover frequency may be lower than or equal to 3000 Hz. In some embodiments, to further ensure the sound leakage reduction effect of the air conduction vibrator, the crossover frequency may not be higher than 2500 Hz. In some embodiments, to further ensure the output performance of the air conduction vibrator, the crossover frequency may not be higher than 2000 Hz.

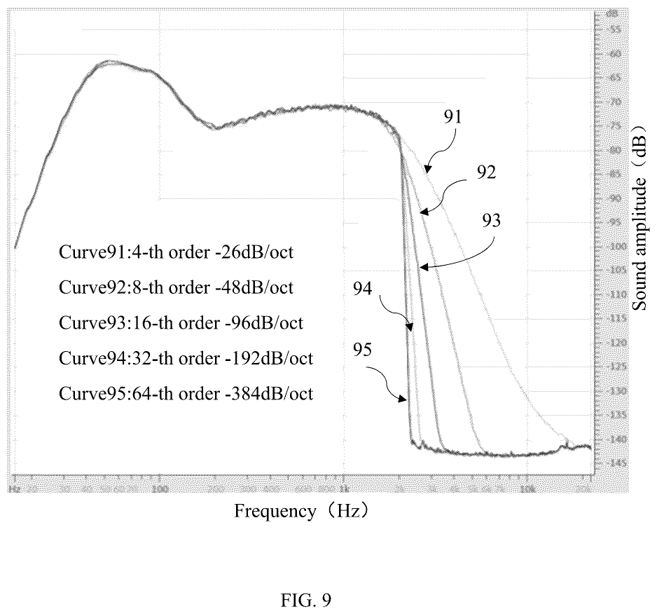

FIG. 9 is a schematic diagram illustrating second audio signal curves obtained after low-pass filtering of different orders according to some embodiments of the present disclosure.

As shown in FIG. 9, five curves 91, 92, 93, 94, and 95 are second audio signal curves obtained by performing low-pass filtering on an original audio signal using low-pass filters of orders 4, 8, 16, 32, and 64, respectively. For a convenient comparison, a cutoff frequency of each low-pass filter of the various orders is 2 kHz. A corresponding crossover frequency may also be 2 kHz.

An order of a filter refers to a parameter reflecting an ability of the filter to perform a filtering process on a signal. For example, for a high-pass filter and a low-pass filter, the order is a total count of capacitors and inductors in the filter. For a band-pass filter, the order is a total count of parallel resonators. For a band-stop filter, the order is a total count of series resonators and parallel resonators.

The higher the order of the low-pass filter, the less the portion above the cutoff frequency of the second audio signal obtained after filtering, the less the high-frequency vibrations the air conduction vibrator 12 may generate after the cutoff frequency, and the less the high-frequency sound leakage.

As shown in FIG. 9, before the cutoff frequency, the curves 91, 92, 93, 94, and 95 substantially coincide. After the cutoff frequency, the curves 91, 92, 93, 94, and 95 all show a downward trend. Moreover, after the cutoff frequency, in the order from curve 91 to curve 95, the larger the order, the steeper the curve, the faster the curve decreases, and the larger the absolute value of the slope of the curve. That is, the larger the order of the filter, the better the filtering effect on the signal.

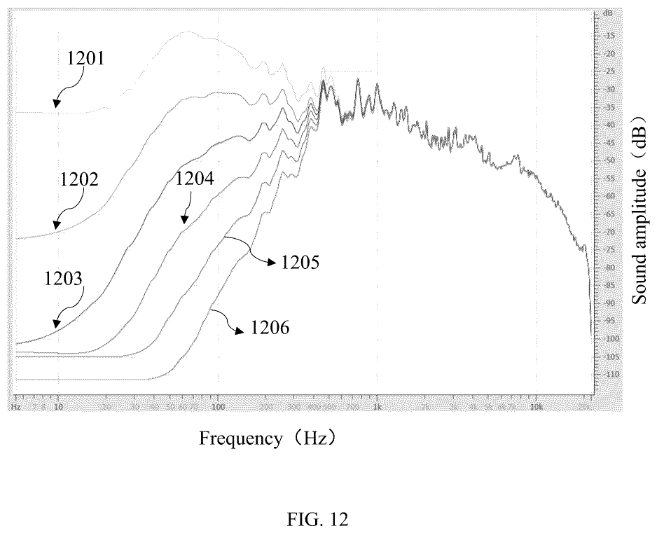

In some embodiments, the slope of the curve may be obtained by sampling and calculating the second audio signal curve. More descriptions regarding the specific calculation manner may be found in FIG. 12 and the related descriptions.

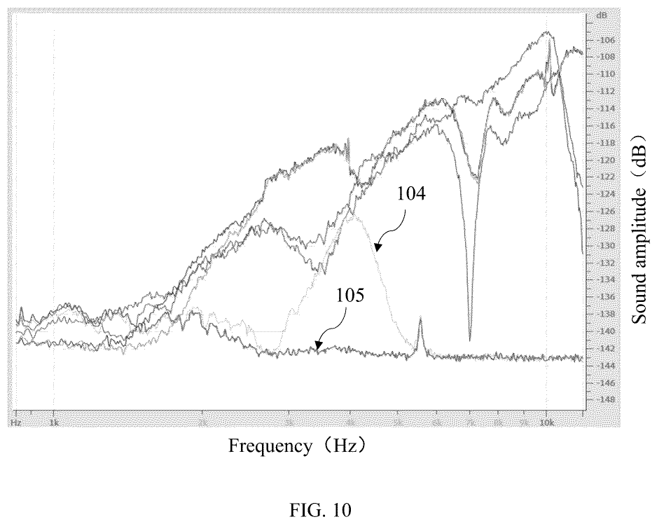

FIG. 10 is a schematic diagram illustrating sound leakage curves obtained after filtering of different orders according to some embodiments of the present disclosure.

A curve 104 corresponds to the curve 91 in FIG. 9, which is the sound leakage curve of the second audio signal after 4th-order filtering. A curve 105 corresponds to the curve 92 in FIG. 9, which is the sound leakage curve of the second audio signal after 8th-order filtering. Corresponding to FIG. 9, a cutoff frequency of each of low-pass filters of various orders in FIG. 10 is 2 kHz, and the corresponding crossover frequency may also be 2 kHz. As shown in FIG. 10, the curve 104 and curve 105 in a voice frequency band (before 2 kHz) are low, i.e., the sound leakage of the second audio signal after 4th-order and 8th-order filtering before the cutoff frequency is low. The curve 104 corresponding to the 4th order has a resonance peak near 4 kHz, while the curve 105 corresponding to the 8th order near the frequency corresponding to the resonance peak is significantly lower than the curve 104 and is relatively flat. This is because when the crossover frequency is high (e.g., the crossover frequency is 2 kHz), the second audio signal after 4th-order low-pass filtering has more high-frequency components above the crossover frequency, while the second audio signal after 8th-order low-pass filtering has fewer high-frequency components above the crossover frequency. This indicates that when the crossover frequency is high, the higher the order of the low-pass filter, the fewer the high-frequency air conduction sounds the air conduction vibrator 12 generates above the cutoff frequency.

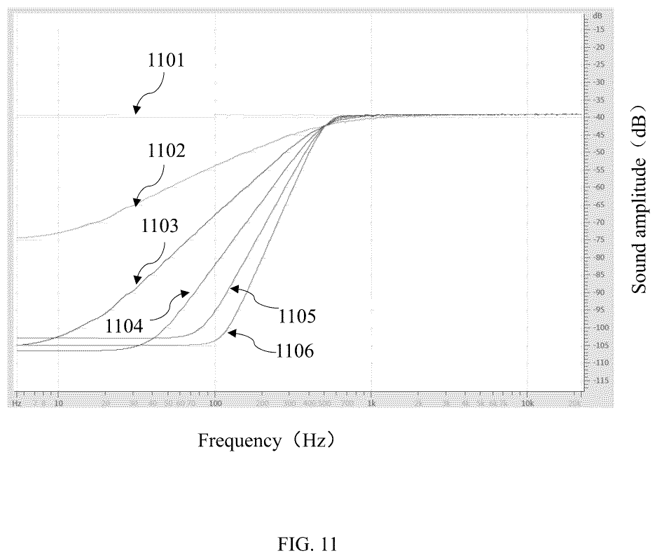

FIG. 11 is a schematic diagram illustrating input signal curves obtained after high-pass filtering of different orders according to some embodiments of the present disclosure. A curve 1101 is an input signal curve when an original audio signal is a white noise signal, and the corresponding order may be regarded as the 0th order, the curve 1101 appears as a horizontal straight line in the schematic diagram of the curve. The other five curves 1102, 1103, 1104, 1105, and 1106 respectively correspond to the schematic diagrams of input signal curves after processing by high-pass filters of orders 1, 2, 3, 4, and 5, respectively. More descriptions regarding the order may be found in FIG. 9 and the related descriptions.

For convenient comparison, the cutoff frequency of each of the high-pass filters of various orders is 500 Hz. The corresponding crossover frequency may also be 500 Hz.

As shown in FIG. 11, the curves 1102, 1103, 1104, 1105, and 1106 all begin to exhibit inflection points at the cutoff frequency. As the order of the high-pass filter gradually increases, descent speeds of the curves 1102, 1103, 1104, 1105, and 1106 gradually increase, the lower the curve in a descent region, the greater the slope corresponding to the curve in the descent region. This indicates that the larger the order of the high-pass filter, the better the high-pass filtering effect.

FIG. 12 is a schematic diagram illustrating first audio signal curves obtained after high-pass filtering of different orders according to some embodiments of the present disclosure.

As shown in FIG. 12, a curve 1201 corresponds to a frequency response curve of an original audio signal. The other five curves 1202, 1203, 1204, 1205, and 1206 respectively correspond to frequency response curves of a first audio signal obtained by processing the original audio signal using high-pass filters of orders 1, 2, 3, 4, and 5, respectively. More descriptions regarding the order may be found in FIG. 9 and the related descriptions.

As shown in FIG. 12, as the order of the high-pass filter gradually increases, descent speeds of curves 1202, 1203, 1204, and 1205 gradually increase. The steeper the curve in a descent region, the larger the corresponding slope, and the fewer low-frequency vibrations the bone conduction vibrator 11 generates below the cutoff frequency. This indicates that the larger the order of the high-pass filter, the better the high-pass filtering effect.

In some embodiments, the order of the filter may be determined based on a slope of a linear region of the input signal curve. The linear region refers to a region on the curve that exhibits a linear relationship. In some embodiments, the descent region after filtering the original audio signal may be equivalent to the linear region.

Taking the high-pass filter as an example, the order of the high-pass filter may be determined based on the slope of the linear region of the first audio signal curve using formula (1) and formula (2):

$$y = k {log}_{10} ( freq ) + b , \qquad ( 1 )$$

$$k = m \times \frac{6}{{log}_{10} 2} , \qquad ( 2 )$$

where k represents the slope, y represents an amplitude of a linear vertical coordinate, freq represents a frequency of a logarithmic horizontal coordinate, b represents a pitch; and m represents a filter order.

In some embodiments, any two points (x₁, y₁), (x₂, y₂) may be selected from the linear region and substituted into formula (1) and formula (2) to obtain formula (3) to formula (6):

$${y}_{1} = k {log}_{10} ( {x}_{1} ) + b , \qquad ( 3 )$$

$${y}_{2} = k {log}_{10} ( {x}_{2} ) + b , \qquad ( 4 )$$

$$k = \frac{( {y}_{1} - {y}_{2} )}{( {log}_{10} ( {x}_{1} ) - {log}_{10} ( {x}_{2} ) )} , \qquad ( 5 )$$

$$m = \frac{k \times {log}_{10} 2}{6} , \qquad ( 6 )$$

Merely by way of example, two points (312.23, −59.8), (150.73, −90.78) may be selected from the linear region and substituted into formula (1) to formula (6) as:

$${y}_{1} = - 59.8 = k {log}_{10} ( 312.23 ) + b$$

$${y}_{2} = - 90.78 = k {log}_{10} ( 50.73 ) + b$$

$$k = \frac{( - 59.8 + 90.78 )}{( {log}_{10} ( 312.23 ) - {log}_{10} ( 50.73 ) )} = \frac{30.98}{0.316275} \approx 97.963$$

$$m = \frac{97.963 \times {log}_{10} 2}{6} \approx 5$$

In some embodiments, considering that the descent region after filtering the original audio signal may not be absolutely linear, errors may exist when equivalent to the linear region, resulting in possible errors in the calculated slope k and the filter order m. In some embodiments, to compensate for the errors, the filter order m may have a compensation of +2 orders.

In some embodiments, to reduce the low-frequency vibration of the bone conduction vibrator 11 and reduce the high-frequency sound leakage of the air conduction vibrator 12 to improve the user experience, an order of the high-pass filtering or an order of the low-pass filtering may not be lower than 2, and the corresponding slope (or an absolute value of the slope) of the linear region is not less than 40. In some embodiments, to further improve the user experience, the order of the high-pass filtering or the order of the low-pass filtering may not be lower than 3, and the corresponding slope (or the absolute value of the slope) of the linear region is not less than 60.

In some embodiments, when the crossover frequency is set low, the bone conduction vibrator 11 generates more low-frequency components. At this time, to reduce the discomfort caused by the low-frequency vibration of the bone conduction vibrator 11, the high-pass filter may be set to a higher order. When the crossover frequency is set high, the air conduction vibrator 12 generates more high-frequency components. At this time, to reduce the sound leakage generated by the air conduction vibrator 12 within the high frequency range, the low-pass filter may be set to a higher order.

In some embodiments, when the crossover frequency is low, for example, when the crossover frequency is within a first frequency range, the order of the high-pass filtering is higher than the order of the low-pass filtering. The first frequency range may be selected based on experience or requirements. In some embodiments, the first frequency range may be close to the second resonance frequency. For example, the first frequency range may be 300 Hz-1000 Hz.

When the crossover frequency is within the first frequency range (a lower frequency interval), from a perspective of attenuating the vibration sensation of bone conduction vibration, the lower the crossover frequency, the more necessary it is to prevent the first audio signal of the bone conduction vibrator 11 from extending to low frequencies. Therefore, the order of the high-pass filtering needs to be set higher. The higher the order of the high-pass filter, the fewer the low-frequency vibrations the bone conduction vibrator 11 may generate below the crossover frequency, thereby attenuating the vibration sensation of low-frequency bone conduction vibration and improving the user experience.

When the crossover frequency is within the first frequency range (a lower frequency interval), the second audio signal of the air conduction vibrator 12 is far from the third resonance frequency, and the restriction on the order of the low-pass filtering of the second audio signal of the air conduction vibrator 12 is relatively small. Attenuating the order of the filter can reduce circuit complexity or algorithm complexity. Therefore, the order of the low-pass filtering can be set lower.

In some embodiments, when the crossover frequency is within in the first frequency range (a lower frequency interval), the order of the high-pass filtering may be higher than the order of the low-pass filtering, thereby preventing the bone conduction vibrator 12 from generating excessive low-frequency vibrations, while reducing the circuit complexity or algorithm complexity of the low-pass filtering.

In some embodiments, when the crossover frequency is set high, for example, when the crossover frequency is within the second frequency range, the order of the low-pass filtering is higher than the order of the high-pass filtering. A minimum value of the second frequency range may be higher than a maximum value of the first frequency range. The second frequency range may be selected based on experience or requirements. In some embodiments, the second frequency range may be close to the third resonance frequency. For example, the second frequency range may be 2000 Hz-3000 Hz. When the crossover frequency is within the second frequency range (a higher frequency range), the higher the crossover frequency, the more necessary it is to prevent the second audio signal of the air conduction vibrator 12 from extending to high frequencies. Therefore, the order of the low-pass filtering needs to be set higher.

When the crossover frequency is within the second frequency range (a higher frequency range), the higher the order of the low-pass filter, the fewer the high-frequency air conduction sounds the air conduction vibrator 12 may generate above the crossover frequency. This can avoid the problem of increased sound leakage caused by the failure of the high-frequency dipole mechanism, and also avoid the influence of the third resonance peak of the front cavity or the rear cavity of the acoustic output device 100 at the third resonance frequency around 3 kHz or 4 kHz (the appearance of the third resonance peak further destroys the far-field sound leakage reduction of the dipole).

When the crossover frequency is within the second frequency range (a higher frequency range), the first audio signal of the bone conduction vibrator 12 is far from a frequency band with obvious vibration sensation, and the restriction on the order of the high-pass filtering for the first audio signal of the bone conduction vibrator 11 is relatively small. Reducing the order of the filter can reduce circuit complexity or algorithm complexity. Therefore, the order of the high-pass filtering can be set lower.

In some embodiments, when the crossover frequency is within the second frequency range (a higher frequency range), the order of the low-pass filtering is higher than the order of the high-pass filtering, thereby avoiding generating excessive high-frequency sound leakage, while reducing the circuit complexity or algorithm complexity of the high-pass filtering.

In some embodiments, when the crossover frequency is within the third frequency range, the order of the low-pass filtering may be the same as the order of the high-pass filtering. A minimum value of the third frequency range may be higher than a minimum value of the first frequency range, and a maximum value of the third frequency range may be less than a maximum value of the second frequency range. The third frequency range may be selected based on experience or requirements. For example, the third frequency range may be 1000 Hz-2000 Hz.

When the crossover frequency is within the third frequency range, the first audio signal of the bone conduction vibrator 12 is far from the frequency band with obvious vibration sensation, and the restriction on the order of the high-pass filtering for the first audio signal of the bone conduction vibrator 11 is relatively small. Moreover, the second audio signal of the air conduction vibrator 12 is far from the third resonant frequency, and the restriction on the order of the low-pass filtering for the second audio signal of the air conduction vibrator 12 is relatively small. The order of the low-pass filtering and the order of the high-pass filtering may both be relatively small to reduce the circuit complexity or algorithm complexity of the high-pass filtering and the low-pass filtering. At this time, the order of the low-pass filtering may be lower than, equal to, or higher than the order of the high-pass filtering.

In some embodiments, through the setting of the processing circuit 120, the order of the high-pass filtering or the low-pass filtering is variable.

By setting the order of the high-pass filtering or the low-pass filtering to be variable, the low-frequency component in the first audio signal or the high-frequency component in the second audio signal can be adjusted. The lower the order of the high-pass filter, the more obvious the low-frequency vibration generated by the bone conduction vibrator 11. Therefore, increasing the order of the high-pass filter helps reduce the low-frequency vibration sensation, which is similar to the effect of increasing the crossover frequency on bone conduction sound. The lower the order of the low-pass filter, the more high-frequency sounds are generated by the air conduction vibrator 12. Therefore, increasing the order of the low-pass filter helps reduce the high-frequency air conduction sound, which is similar to the effect of decreasing the crossover frequency on air conduction sound.

In some embodiments, the order of the high-pass filtering when the crossover frequency is within the first frequency range is higher than the order of the high-pass filtering when the crossover frequency is within the second frequency range.

The high-pass filter is mainly configured to perform the high-pass filtering on the original audio signal to provide a first audio signal at a high frequency for the bone conduction vibrator 11. If the crossover frequency is high, the first audio signal of the bone conduction vibrator 11 is difficult to extend to a low-frequency region, and the restriction on the order of the high-pass filter is relatively small. At this time, from the perspective of reducing circuit complexity or algorithm complexity, the high-pass filter may be set to a lower order. If the crossover frequency is low, it is necessary to prevent excessive low-frequency signals from being mixed into the first audio signal of the bone conduction vibrator 11. At this time, the order of the high-pass filter may be set higher. That is, compared to when the crossover frequency is within a lower frequency range, the order of the high-pass filtering is higher when the crossover frequency is within a higher frequency range.

In some embodiments, the order of the low-pass filtering when the crossover frequency is within the first frequency range is lower than the order of the low-pass filtering when the crossover frequency is within the second frequency range.

The low-pass filter is mainly configured to perform the low-pass filtering on the original audio signal to provide a second audio signal at a low frequency for the air conduction vibrator 12. If the crossover frequency is low, the second audio signal of the air conduction vibrator 12 is difficult to extend to a high-frequency region, and the restriction on the order of the low-pass filter is relatively small. At this time, from the perspective of reducing circuit complexity or algorithm complexity, the low-pass filter may be set to a lower order. If the crossover frequency is high, it is necessary to prevent excessive high-frequency signals from being mixed into the second audio signal of the air conduction vibrator 12. At this time, the order of the low-pass filter may be set higher. Therefore, compared to when the crossover frequency is within the lower frequency range, the order of the low-pass filtering is lower when the crossover frequency is within the higher frequency range.

In some embodiments, the processing circuit 120 may simultaneously adjust the crossover frequency and the order of the high-pass filter/low-pass filter to adjust the components of the first audio signal and the second audio signal, thereby adjusting the high-frequency and low-frequency output effects of the acoustic output device 100, so that the acoustic output device 100 is suitable for different scenarios, and the user experience of the acoustic output device is improved. For example, according to the related descriptions of the different value ranges of the crossover frequency mentioned above, after moving the crossover frequency to a lower frequency (decreasing the crossover frequency), the low-frequency components generated by the bone conduction vibrator 11 increase. To prevent excessive low-frequency signals from being mixed into the first audio signal of the bone conduction vibrator 11, the order of the high-pass filtering may be increased accordingly. After moving the crossover frequency to a higher frequency (increasing the crossover frequency), the high-frequency components generated by the air conduction vibrator 12 increase. To prevent excessive high-frequency signals from being mixed into the second audio signal of the air conduction vibrator 12, the order of the low-pass filtering may be increased accordingly.

Similarly, after reducing the order of the high-pass filter, the bone conduction vibrator 11 generates more low-frequency vibrations. At this time, a higher crossover frequency may be adopted accordingly to avoid generating more low frequencies. After reducing the order of the low-pass filter, the air conduction vibrator 12 generates more high-frequency sounds. At this time, a lower crossover frequency may be adopted accordingly to avoid generating more high frequencies.

The basic concepts have been described above. Obviously, for those skilled in the art, the above detailed disclosure is merely an example and does not constitute a limitation to the present disclosure. Although not explicitly stated herein, those skilled in the art may make various modifications, improvements, and corrections to the present disclosure. Such modifications, improvements, and corrections are suggested in the present disclosure, so they still belong to the spirit and scope of the exemplary embodiments of the present disclosure.

Meanwhile, the present disclosure uses specific words to describe the embodiments of the present disclosure. For example, “one embodiment,” “an embodiment,” and/or “some embodiments” mean a certain feature, structure, or characteristic related to at least one embodiment of the present disclosure. Therefore, it should be emphasized and noted that “an embodiment” or “one embodiment” or “an alternative embodiment” mentioned two or more times in different places in the present disclosure does not necessarily refer to the same embodiment. In addition, certain features, structures, or characteristics in one or more embodiments of the present disclosure can be appropriately combined.

Similarly, it should be noted that, in order to simplify the expression disclosed in the present disclosure and thereby help the understanding of one or more inventive embodiments, sometimes multiple features are grouped into one embodiment, drawing, or description thereof in the foregoing description of the embodiments of the present disclosure. However, this disclosure manner does not mean that the object of the present disclosure requires more features than those mentioned in the claims. Rather, claimed subject matter may lie in less than all features of a single foregoing disclosed embodiment.

Finally, it should be understood that the embodiments described in the present disclosure are only used to illustrate the principles of the embodiments of the present disclosure. Other variations may also fall within the scope of the present disclosure. Thus, merely by way of example and not limitation, alternative configurations of an embodiment of the present disclosure may be considered as consistent with the teachings of the present disclosure. Accordingly, the embodiments of the present disclosure are not limited to the embodiments explicitly described and introduced in the present disclosure.

1. An acoustic output device, comprising:
a housing;
a bone conduction vibrator, configured to generate a bone conduction sound wave, wherein the bone conduction sound wave is transmitted to a cochlea through the housing to generate a sound;
an air conduction vibrator, configured to generate an air conduction sound wave, wherein the air conduction sound wave is transmitted to an ear of a user through a sound guiding hole on the housing; and
a processing circuit, configured to provide a first audio signal to the bone conduction vibrator and a second audio signal to the air conduction vibrator, wherein:
the processing circuit is further configured to adjust a low-frequency component in the first audio signal or adjust a high-frequency component in the second audio signal;
wherein the first audio signal is obtained by the processing circuit performing high-pass filtering on an electrical signal containing audio information, and the second audio signal is obtained by the processing circuit performing low-pass filtering on the electrical signal containing the audio information, and an order of the high-pass filtering or an order of the low-pass filtering is variable.

2. The acoustic output device of claim 1, wherein the processing circuit is configured to provide, based on a crossover frequency, the first audio signal to the bone conduction vibrator and the second audio signal to the air conduction vibrator; wherein
the crossover frequency is variable, the first audio signal includes components whose frequencies are above the crossover frequency, and the second audio signal includes components whose frequencies are below the crossover frequency.

3-6. (canceled)

7. The acoustic output device of claim 2, wherein when the crossover frequency is within a first frequency range, the order of the high-pass filtering is higher than the order of the low-pass filtering.

8. The acoustic output device of claim 7, wherein when the crossover frequency is within a second frequency range, the order of the low-pass filtering is higher than the order of the high-pass filtering, and a maximum value of the first frequency range is less than a minimum value of the second frequency range.

9. (canceled)

10. The acoustic output device of claim 2, wherein the order of the high-pass filtering when the crossover frequency is within a first frequency range is higher than the order of the high-pass filtering when the crossover frequency is within a second frequency range, and a maximum value of the first frequency range is less than a minimum value of the second frequency range.

11. The acoustic output device of claim 2, wherein the order of the low-pass filtering when the crossover frequency is within a first frequency range is lower than the order of the low-pass filtering when the crossover frequency is within a second frequency range, and a maximum value of the first frequency range is less than a minimum value of the second frequency range.

12. (canceled)

13. The acoustic output device of claim 1, wherein the first audio signal and the second audio signal have a crossover frequency, and the order of the high-pass filtering when the crossover frequency is within a first frequency range is higher than the order of the high-pass filtering when the crossover frequency is within a second frequency range, and a maximum value of the first frequency range is less than a minimum value of the second frequency range.

14. The acoustic output device of claim 1, wherein the first audio signal and the second audio signal have a crossover frequency, and the order of the low-pass filtering when the crossover frequency is within a first frequency range is lower than the order of the low-pass filtering when the crossover frequency is within a second frequency range, and a maximum value of the first frequency range is less than a minimum value of the second frequency range.

15. The acoustic output device of claim 1, wherein the order of the high-pass filtering or the order of the low-pass filtering is higher than or equal to 3.

16. The acoustic output device of claim 15, wherein the first audio signal and the second audio signal have a crossover frequency, and when the crossover frequency is within a first frequency range, the order of the high-pass filtering is higher than the order of the low-pass filtering.

17. The acoustic output device of claim 16, wherein when the crossover frequency is within a second frequency range, the order of the low-pass filtering is higher than the order of the high-pass filtering, and a maximum value of the first frequency range is less than a minimum value of the second frequency range.

18. The acoustic output device of claim 1, wherein the crossover frequency is higher than or equal to 300 Hz.

19. The acoustic output device of claim 1, wherein the crossover frequency is lower than or equal to 3000 Hz.

20. The acoustic output device of claim 1, wherein the first audio signal and the second audio signal have a crossover frequency, and the processing circuit is further configured to: receive a trigger signal, and enhance the low-frequency component with the frequency below the crossover frequency in the first audio signal based on the trigger signal or attenuate the high-frequency component with the frequency above the crossover frequency in the second audio signal based on the trigger signal.

21. (canceled)

22. The acoustic output device of claim 20, wherein enhancing the low-frequency component with the frequency below the crossover frequency in the first audio signal includes: lowering the crossover frequency.

23. The acoustic output device of claim 20, wherein
enhancing the low-frequency component with the frequency below the crossover frequency in the first audio signal includes: lowering an order of the high-pass filtering.

24. (canceled)

25. The acoustic output device of claim 20, wherein attenuating the high-frequency component with the frequency above the crossover frequency in the second audio signal includes: lowering the crossover frequency.

26. The acoustic output device of claim 20, wherein
attenuating the high-frequency component with the frequency above the crossover frequency in the second audio signal includes: increasing an order of the low-pass filtering.

27. The acoustic output device of claim 20, wherein the trigger signal is obtained by recognizing an audio content through the acoustic output device or a processing device connected to the acoustic output device.

28. The acoustic output device of claim 20, wherein the trigger signal is obtained by recognizing a surrounding environment through the acoustic output device or a processing device connected to the acoustic output device.
